(19) United States
(12) Patent Application Publication
(10) Pub. No.: US 2009/0030854 A1
(43) Pub. Date: Jan. 29, 2009

(54) POSTAGE WEIGHT COMPUTATION

(76) Inventors: Ehud Chatow, Palo Alto, CA (US); Carl S. Chow, Fremont, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/828,345

(22) Filed: Jul. 25, 2007

(51) Int. Cl. G01G 19/413

(52) U.S. Cl. 705/407

(57) ABSTRACT

Postage weight of a print item is computed as a function of certain print characteristics of the print item. The postage weight may be computed prior to printing the print item.

### BACKGROUND

Postage is typically added to a package by weighing the package on a scale, looking up a postage rate, and adding the appropriate stamp or stamps.

Stamps.com advertises a different approach. Postage can be added to a package by weighing the package on a digital scale, and using Stamps.com's software to calculate and print postage for the package. The software can be run on a personal computer, and the postage can be printed with a local printer.

### BRIEF DESCRIPTION OF THE DRAWINGS

FIG. 1 is an illustration of a method of computing postage weight according to an embodiment of the present invention.

FIGS. 2-4 are illustrations of methods in accordance with embodiments of the present invention.

FIG. 5 is an illustration of a machine in accordance with an embodiment of the present invention.

### DETAILED DESCRIPTION

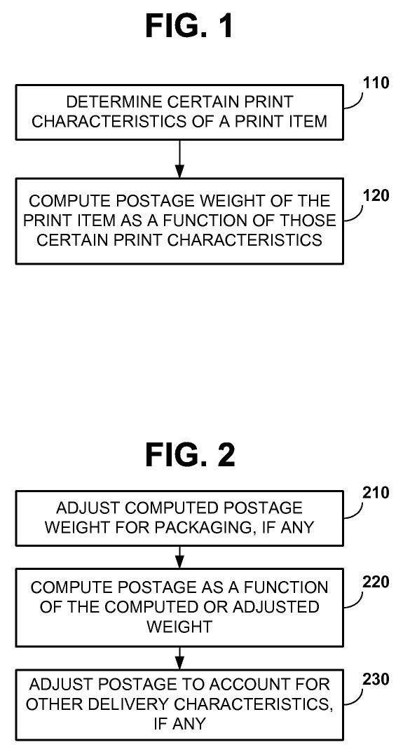

Reference is made to FIG. 1, which illustrates a method of computing postage weight of a print item without manually weighing the print item. A print item refers to an item that has been or will be printed. A print item is not limited to anything in particular. A print item could include a poster, a magazine, a catalog, a book, a report, a photo book, a newsletter, etc. A print item could include more than one poster, magazine, catalog, book, report, photo book, newsletter, etc.

The method includes determining certain print characteristics of the print item (block 110). Certain print characteristics of the print item will be known prior to printing. Examples of print characteristics include the type of print media for the print item, and the number of pages that will be printed. Other examples of print characteristics include, but are not limited to, covers, bindings, inserts, varnish and lamination and other finishings.

The method further includes computing postage weight of the print item as a function of those certain print characteristics (block 120). Typically, the type of print media and number of pages will be known prior to printing. Once the type of print media is known, the weight of each media substrate can be looked up. Weight of the ink may be considered negligible, so knowledge of the print media type and number of pages alone can be used to compute the postage weight.

If, for some reason, information about the print media cannot be looked up, the weight of the print item can be computed as a product of number of pages, page area (page length×page width), and page weight per unit area. The weight per unit area could be looked up.

As used herein, the term “compute” and its derivatives (e.g., computing) exclude mental processes.

Consider the following example of a magazine. Postage weight of each copy is computed from the following print characteristics: type of paper stock, size and finish, and number of pages. Paper is specified in terms of a substance or basis weight. For example, regular 50 pound paper means that 500 sheets of this paper, with each sheet measuring 17×22 inches (the basis size), weighs 50 pounds. In general, the basis weight equals the weight of 500 sheets of that paper in a basic size.

In this example, the finished size of the magazine is either letter size (8½×11) or 8″×10⅜″. The magazine will have a saddle stitching as a finish. Two staples through the spine of the magazine will keep the pages in order. The face-edge is trimmed.

An 11×17 sheet can yield four pages because the sheet is folded in half to yield four (8½×11) pages, and the printing is double-sided. The magazine's publisher can specify or project the total number of pages in the magazine and, therefore, the number of 11×17 sheets.

In general, the total weight of each magazine equals the sum of weights of the paper, ink, and finishing (stitching and two staples). However, the weight of the ink is negligible and, therefore, can be excluded from the weight computation.

The postage weight of a print item may be computed before the item is printed, once the relevant print characteristics become known. For example, the postage may be computed at any of design, editing, prepress, and publication planning. The postage weight may be computed while the item is in electronic form (e.g., as a pdf file, as a print job).

Reference is now made to FIG. 2. After the postage weight of a print item has been computed, the postage may be computed. At block 210, the computed postage weight can be adjusted for packaging (e.g., an envelope, box, filling) and other weight-adding factors, if any.

At block 220, postage is determined as a function of the computed or adjusted weight, and also as a function of carrier-specific factors, such as destination, packaging (e.g., envelope, package, box), type of delivery (first class, one-day service, two-day service, three-day service, etc.), whether the sender is a for-profit or non-profit organization, and the like. For example, the U.S. Post Office requests shape (e.g., postcard, letter, and large envelope), weight and zip code for U.S. domestic mail, first class. The postage can be determined by looking up the weight in a rate table.

At block 230, the postage may be adjusted to account for other delivery characteristics, if any. Examples of delivery characteristics include, but are not limited to special handling (Saturday delivery, dangerous goods), insurance, etc, and packaging material. Additional examples of characteristics that can cause postage to change include advertisement level and sorting level.

Thus, the postage weight and correct postage of a print item can be computed before the print item is actually printed. A method according to an embodiment of the present invention eliminates the need to actually print a print item and measure it on a scale in order to compute postage.

Computing the postage weight prior to printing has additional advantages for print items such as catalogs, magazines, and newsletters. Since these items are typically mailed without packaging or special delivery characteristics, the postage weight can be computed solely from weight of the print characteristics.

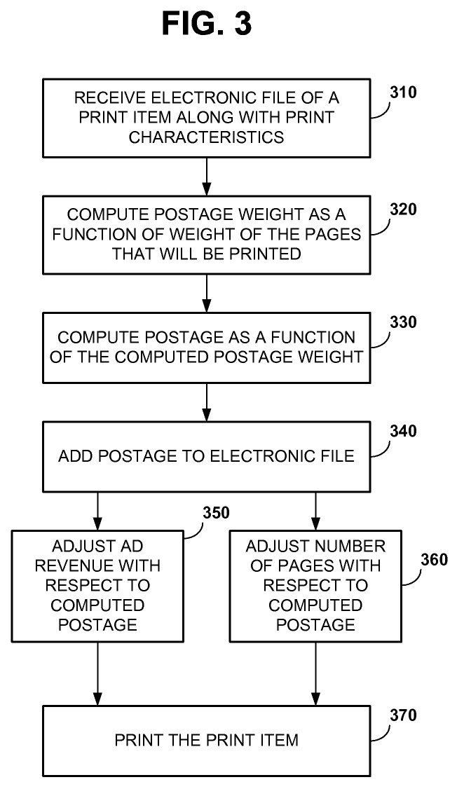

Reference is now made to FIG. 3, which illustrates a method for printing magazines, newspapers and other publications that do not have packaging, special delivery features, etc. At block 310, an electronic file of a print item is received along with print characteristics. The file may be received in document format (e.g., as a pdf or XML file), as a print job, etc.

At block 320, the postage weight is computed as a function of the weight of the pages that will be printed. The weight of the ink is disregarded. At block 330, the postage is computed as a function of the computed postage weight.

At block 340, the electronic file is modified to include a digital stamp or imprint permit that bears the computed postage. Thus, when the print item is printed, the postage is printed along with it. In addition to saving the time and effort of weighing a print item after it is printed, the method of FIG. 3 can eliminate the step of adding the postage to the printed item.

In the alternative, the print item is printed and the computed postage is then added. For instance, the print item is printed, and the postage is printed out separately on special media and affixed to the printed item.

At block 350, ad revenue can be adjusted with respect to the computed postage. Ad pages can be added or removed (or not added or not removed) with respect to the computed postage. An ad page can be removed (or not added) if the extra revenue from that ad page is less than the extra cost of postage for that ad page (that is, whether additional ad revenue>increase in postage). Conversely, an ad page can be added (or not removed) if the increase in ad revenue is greater than extra cost of postage for that ad page. For example, an additional ad page adds 20 cents in postage costs but generates only 15 cents of additional ad revenue per issue. The additional ad page would not be added to the publication, or the page would be automatically removed and a new postage weight would be computed. If, on the other hand, the additional page generates 25 cents in revenue, it would not be removed from the publication, or it would be added and a new postage weight would be computed.

At block 360, the number of pages or other print characteristics may be adjusted with respect to the computed postage. Changes in number of pages, template chosen (paper type or size) and percentage of advertisement can be significant enough to move the postage cost on regional or country tables from one level to the next. Thus, before a publication is even printed, changes to the print characteristics can be made to prevent moving the postage cost to a higher level, or changes can be made to move the costs to a lower level. Thus avoided is an iterative process of printing an item, measuring its weight manually, determining the correct postage based on the weight, adjusting the print item if its measured weight is excessive, printing it again, measuring its weight again, and so on.

The weight can be adjusted as a step function. For example, a four page publication costs X in postage. An eight page publication also costs X in postage. However, a twelve page publication costs Y in postage. Thus, the number of pages that increase postage to the next level can be determined. This allows decisions to be made up front to design a publication that comes in under a certain weight class. Thus avoided is overpaying for postage because of a slight miss in weight. Thus avoided is an iterative process of printing, weighing, adjusting, printing again, weighting again, etc.

At block 370, the print item is printed.

A method according to an embodiment of the present invention is especially beneficial for customized instances of a publication. Customizing instances of a publication is described in assignee's U.S. Ser. No. 11/694,914 filed 30 Mar. 2007, which is incorporated by reference. The instances may be customized according to recipient interests. Recipient interests might include geographic location, reading interests, hobbies, affiliations, memberships, desired level of advertising, etc. An instance may contain customized content (e.g., stories of interest, regional information, certain editorials, photos from specific places of interest to a recipient). An instance may contain a customized design (e.g., an appropriate template or style sheet, a theme for special occasion, a layout with cartographic styles for a recipient interested in travel, use of a predominant color for a holiday, certain image borders or frames, fonts, page numbers and other graphical elements). An instance may contain customized advertisements.

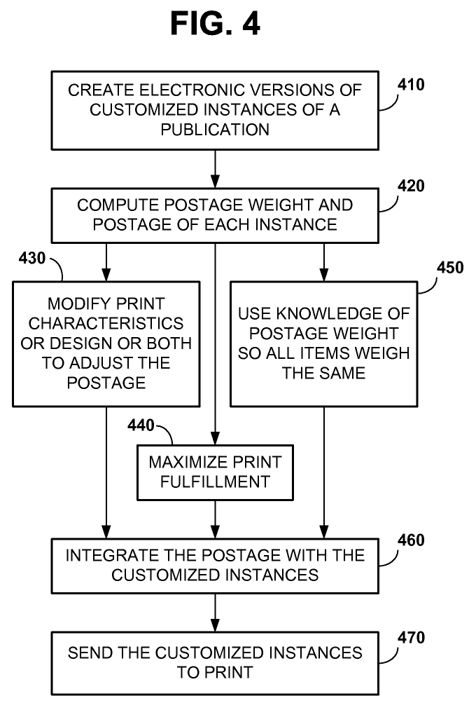

Reference is now made to FIG. 4, which illustrates an example of creating customized instances of a publication. At block 410, electronic versions of the customized instances of a publication are created. The customized instances can be created by using an embodiment of a Publisher Interface, which is disclosed in assignee's U.S. Ser. No. 11/741,718 filed 27 Apr. 2007, which is incorporated herein by reference.

At block 420, postage weight and postage of each instance is computed. Since the publication is customized, different instances are likely to have different lengths, use different media types, have different finishings, etc. Thus, different postage weights and postages are likely to be computed for the different instances.

Creating the instances might be subject to a budget constraint, cost target, or other target. Knowing the postage prior to printing can help meet that target. Knowing the postage prior to printing can also help with planning, especially for commercial publications that are widely circulated.

At block 430, print characteristics can be modified to adjust the postage. Characteristics that can be modified include, but are not limited to, different type of print media, fewer pages, etc. For example, the number of pages or media type or both can be optimized to fit into a lower postage rate. Different combinations of paper types, some lighter than others, might also be used.

Also at block 430, the design of the instances could be modified to adjust the postage. The publication can be modified, for example, by selecting a different template for the print item selecting a different cover paper type, etc. Certain customized instances could be reformatted to shorten their length and thereby reduce their weight.

Instead of being used to reduce costs, computing postage can be used to maximize print fulfillment (block 440). As a first example, knowledge of the postage can be used to maximize document length. Maximizing document length can involve determining how many pages of a document can be added before having to pay additional postage.

As a second example, instances can be bundled prior to printing in order to maximize the number of pages that can be sent without increasing postage. For example, different instances can be combined into a single run as a bundle of personalized magazines. Postage for the bundle would cost less than the sum of postage for the individual magazines in the bundle. If the instances will be printed by a digital printing press, the bundle can be combined into a single print run. The digital printing press has the ability to vary the print run to produce the customized instances.

At block 450, knowledge of the postage weight can be used so all items weigh the same. This is especially useful for permit imprints. Permit imprint is a popular and convenient way of paying for postage, especially for high volume mailings. To use the permit imprint, however, mailed pieces must all weight the same. Adjusting the number of pages and other print characteristics can ensure that all print items weigh the same.

At block 460, the postage may be integrated with the customized instances. A digital stamp may be added to the electronic file (e.g., on the cover page) of each customized instance. At block 470, the customized instances are sent to print. For example, a print job is sent to a print service provider, who prints the customized instances along with the correct postage.

Thus, computing the postage of each customized instance gives a better idea of the costs of printing the publication. Unlike the printing of a conventional publication (where all copies of the publication are identical), the costs of customized instances of a publication can vary widely.

In addition, computing the postage enables cost adjustments to be made, targets to be met, and print fulfillment to be maximized. Computing the postage prior to printing saves labor, reduces the iterative process (i.e., of printing items, measuring their weight, making adjustments based on the measured weight, and so on) in order to achieve weight or cost targets.

A method according to an embodiment of the present invention is not limited to computing postage prior to printing. The postage could be computed after a print item has been printed. Such post-printing computation could be beneficial, for example, to verify or assess the accuracy of conventional methods of determining postage (e.g., weighing an item and looking up its postage rate).

A method according to an embodiment of the present invention is not limited to any particular software implementation. In some embodiments, the software implementation could include an “advisory wizard.” For example, a word processing or publishing program could include the advisory wizard. In some embodiments, a program that assists in designing and planning a publication could compute postage weight and postage.

In some embodiments, a Publisher Interface could compute postage. The Publisher Interface could also make modifications to print and delivery characteristics, make modifications (e.g., find new templates) to the customized instances, and maximize print fulfillment.

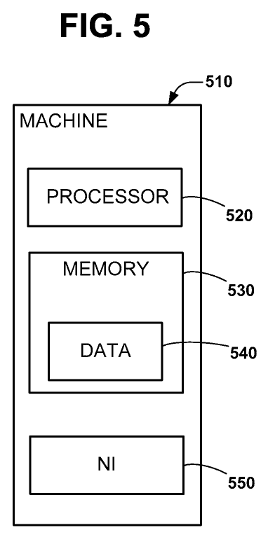

Reference is made to FIG. 5, which illustrates a general hardware implementation of a method according to an embodiment of the present invention. The hardware implementation includes a machine 510 having a processor 520, and memory 530. The memory 530 includes data 540 (e.g., code) for causing the processor 520 to perform a method according to an embodiment of the present invention. The machine 510 could also include a network interface 550, which allows the machine 510 to look up postage rates on-line or to communicate with an on-line service provider in order to obtain rates, order a delivery, etc.

The machine 510 also includes a means (not shown) for accessing the print characteristics. There are a variety of ways in which this can be done. As a first example, the machine 510 includes an input device (e.g., keyboard) for manually inputting the print characteristics. As a second example, the machine 510 runs software that analyzes an electronic file (e.g., a document or print job) to determine the print characteristics needed to compute postage weight.

The actual hardware implementation is not limited to any particular type. In some embodiments, the hardware implementation might include a personal computer or mobile device. For instance, a person could run a wizard or the Publication Interface or other program on a personal computer or mobile device to compute the postage weight and postage of a print job prior to printing.

In some embodiments, the hardware implementation might include a server system. As a first example, a person contacts (e.g., calls, e-mails) a company (e.g., a print shop, an overnight service) and supplies the print characteristics of a print item. The company's server computes the postage, and returns the computed postage to that person.

As a second example, a customer uses a personal computer or mobile device to access a web site of an overnight service company (e.g., FedEx). Print characteristics are uploaded to a web-based server of the overnight service company, and the server computes the postage and informs the customer of the cost of delivery (as a function of the computed weight). The web site can also be used to plan the delivery of the print item.

1. A method comprising computing postage weight of a print item as a function of certain print characteristics of the print item.

2. The method of claim 1, wherein the postage weight is computed solely from print characteristics.

3. The method of claim 1, wherein the postage weight is computed from the weight of the media upon which the item will be printed.

4. The method of claim 3, wherein ink weight is ignored.

5. The method of claim 1, wherein the postage weight is computed before the print item is printed.

6. The method of claim 1, further comprising determining postage as a function of the computed print weight.

7. The method of claim 6, further comprising modifying the print item to bear the computed postage prior to printing the print item.

8. The method of claim 6, further comprising adjusting ad revenue with respect to the computed postage prior to printing the print item.

9. The method of claim 6, further comprising adjusting the number of pages that will be printed with respect to the computed postage, the number of pages adjusted prior to printing the print item.

10. The method of claim 6, further comprising computing an initial postage from the postage weight, modifying the print characteristics in order to reduce the initial postage weight and postage prior to printing the print item.

11. The method of claim 10, wherein modifying the print item includes selecting a different template for the item.

12. The method of claim 6, further comprising computing an initial postage from the postage weight; modifying the print item to maximize fulfillment at that postage; and thereafter printing the print item.

13. The method of claim 12, wherein modifying the print item includes maximizing document length for a given postage amount.

14. The method of claim 6, further comprising modifying the print item to meet a target postage prior to printing the print item.

15. The method of claim 1, wherein postage weight is computed for each of a plurality of customized instances of a publication.

16. The method of claim 15, wherein further comprising bundling different customized instances into a bundle to achieve a target postage prior to printing the bundle.

17. Apparatus comprising a processor for computing postage weight of a print item according to the method of claim 1.

18. An article comprising memory encoded with data for causing a processor to compute the postage weight of a print item according to the method of claim 1.

19. Apparatus for computing postage weight of a print item without actually weighing the print item, the postage computed as a function of print characteristics of the print item.

20. An article comprising memory encoded with data for causing a processor to compute postage weight of a print item before the print item is printed, the postage computed as a function of page weight of the print item.
